(19) United States
(12) Patent Application Publication
(10) Pub. No.: US 2017/0124352 A1
(43) Pub. Date: May 4, 2017

(54) MOUNTING METHOD AND SYSTEM OF EXTERNAL STORAGE DEVICE BASED ON DUAL SYSTEM

(71) Applicant: YULONG COMPUTER TELECOMMUNICATION SCIENTIFIC (SHENZHEN) CO., LTD., Shenzhen (CN)

(72) Inventor: ZHANG-ZHI ZOU, Shenzhen (CN)

(21) Appl. No.: 15/405,315

(22) Filed: Jan. 13, 2017

Related U.S. Application Data
(63) Continuation-in-part of application No. PCT/CN2015/072008, filed on Jan. 30, 2015.

(30) Foreign Application Priority Data
Jan. 15, 2015 (CN) 201510020601.3

(51) Int. Cl. G06F 21/62; G06F 12/14

(52) U.S. Cl. CPC G06F 21/6281; G06F 12/14; G06F 2212/1052; G06F 2221/032

(57) ABSTRACT

Embodiments of the present disclosure provides a mounting method and system of external storage device of a dual system, the dual system includings a first operating system and a second operating system. The mounting method includes: transmitting a mounting request to the second operating system through the first operating system when the external storage device is mounted on the second operating system; unmounting the external storage device that is mounted on the second operating system when the second operating system receives the mounting request; mounting the external storage device on the first operating system when the second operating system successfully unmounts the external storage device. In this way, operation steps of mounting the external storage device in the dual system are greatly simplified, so that it is convenient for users to utilize, and user experience is improved.

### CROSS-REFERENCE TO RELATED APPLICATIONS

This application is a continuation-in-part of International Application No. PCT/CN2015/072008, filed on Jan. 30, 2015. This application claims priority of Chinese Patent Application No. 201510020601.3 filed on Jan. 15, 2015, entitled “system processing method, system processing device and terminal,” in the SIPO (State Intellectual Property Office of the People's Republic of China), the entire contents of which are incorporated by reference in this application.

### FIELD

The present disclosure relates to a technical field of communication, and specifically to a mounting method and a system of external storage based on a dual system.

### BACKGROUND

When using a dual system including an ordinary system and a security system, an external storage device (e.g., SD (Secure Digital Memory Card)) is only mounted on one operating system. If the external storage device is mounted on the ordinary system, the security system cannot operate the external storage device. If the external storage device is mounted on the security system, the ordinary system cannot operate the external storage device. When a user is using the security system and the external storage device is mounted on the ordinary system, if the user wants to use the external storage device in the security system, the user needs to manually switch to the ordinary system and unmount the external storage device in system settings of the ordinary system. Then the user manually switches to the security system and manually mounts the external storage device in system settings of the security system, vice versa. By using a prior method for mounting the external storage device, more than ten operations are executed by the user during a whole operating process, the operations is fussy and a user experience is bad.

In conclusion, it is obvious that prior art has inconveniences and disadvantages, and it is needed to improve.

### BRIEF DESCRIPTION OF THE DRAWINGS

FIG. 1 is a structure schematic of a mounting system of an external storage based on a dual system of the present disclosure;

FIG. 2 is a preferable structure schematic of the mounting system of the external storage based on the dual system of the present disclosure;

FIG. 3 is a flowchart of a mounting method of an external storage based on a dual system of the present disclosure;

FIG. 4 is a preferable flowchart of the mounting method of the external storage based on the dual system of the present disclosure.

FIG. 5 shows a schematic diagram of one embodiment of a communication terminal according to the present disclosure.

### DETAILED DESCRIPTION

For clarity of illustration of objectives, technical solutions and advantages of the present disclosure, drawings combined with detailed description illustrate the embodiments of the present disclosure hereinafter. It should be understood that described embodiments hereinafter only interpret the present disclosure, but is not limited the present disclosure.

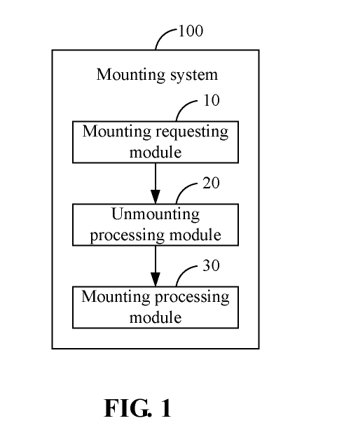

FIG. 1 is a structure schematic of a mounting system of the external storage based on the dual system of the present disclosure. The dual system includes a first operating system and a second operating system, the first operating system is a security system or an ordinary system, the second operating system is an ordinary system or a security system. A mounting system 100 is applied to communication terminals, such as a mobile phone, a PDA (Personal Digital Assistant), a tablet computer, and the like, and the mounting system 100 includes a mounting requesting module 10, an unmounting processing module 20 and a mounting processing module 30.

When an external storage device is mounted on the second operating system, the mounting requesting module 10 transmits a mounting request to the second operating system through the first operating system. The external storage device may be a SD (Secure Digital Memory Card), etc. Preferably, when a user is operating the security system and the external storage device is mounted on the ordinary system, if the user wants to mount the external storage device on the security system, the mounting request is transmitted to the ordinary system through the security system. Or when a user is operating the ordinary system, and the external storage device is mounted on the security system, if the user wants to mount the external storage device on the ordinary system, the mounting request is transmitted to the security system through the ordinary system. Specifically, the user may send the mounting request by clicking a predetermined icon, a menu item, or inputting a predetermined gesture in the first operating system.

When the second operating system receives the mounting request, the unmounting processing module 20 automatically unmounts the external storage device that is mounted on the second operating system. Preferably, when the ordinary system receives the mounting request from the security system, the external storage device mounted on the ordinary system is unmonted. Or when the security system receives the mounting request from the ordinary system, the external storage device mounted on the security system is unmonted.

When the second operating system successfully unmounts the external storage device, the mounting processing module 30 automatically mounts the external storage device on the first operating system. Preferably, when the ordinary system successfully unmounts the external storage device, the security system mounts the external storage device on the security system. Or when the security system successfully unmounts the external storage device, the ordinary system mounts the external storage device on the ordinary system.

It can be seen that the present disclosure can realize a quick mounting of the external storage device in the security system, and a quick mounting of the external storage device in the ordinary system. The security system is utilized to process voice services, data of the voice services is security and private data, such as, contacts, call logs, messages, and so on. The ordinary system is utilized to process data services, data of the data services is not security data, such as, browsing pages, watching online videos, and so on.

Combining with characterizations of the dual system, operation steps of mounting the external storage device in the dual system are greatly simplified, so that it is convenient for users to utilize, and user experience is improved.

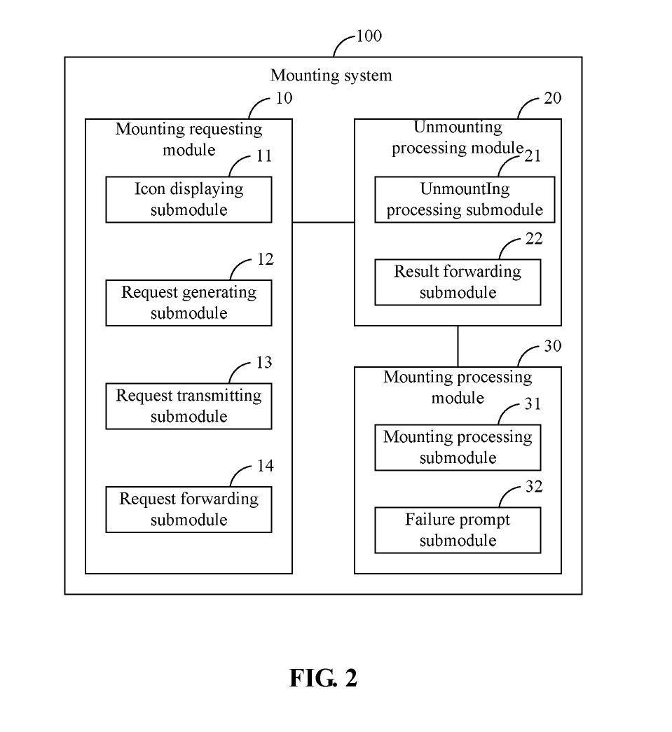

FIG. 2 is a preferable structure schematic of the mounting system of the external storage based on the dual system of the present disclosure. The dual system includes a first operating system and a second operating system, the first operating system is a security system or an ordinary system, the second operating system is an ordinary system or a security system. The mounting system 100 includes a mounting requesting module 10, an unmounting processing module 20 and a mounting processing module 30.

The word “unit” as used hereinafter, refers to logic embodied in hardware or firmware, or to a collection of software instructions, written in a programming language, such as, for example, Java, C, or assembly. One or more software instructions in the function units may be embedded in firmware (e.g., the mounting system 100). It will be appreciated that the function units may include connected logic units, such as gates and flip-flops, and may include programmable units, such as programmable gate arrays or processors. The function units described herein may be implemented as either software and/or hardware units and may be stored in a storage device. The storage device can be any type of non-transitory computer-readable storage medium or other computer storage device, such as a hard disk drive, a compact disc, a digital video disc, a tape drive, a storage card (e.g., a memory stick, a smart media card, a compact flash card), or other suitable storage medium, for example. The function units, when controlled by a processor, can execute the functions as mentioned above or as follows.

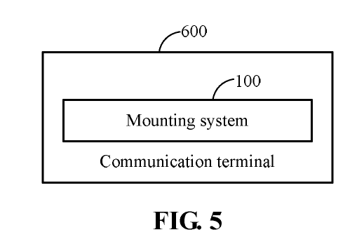

The mounting system 100 can be a firmware, which may be installed in a terminal (e.g., a communication terminal 600 shown in FIG. 5), which includes at least one processor and a storage device. The mounting requesting module 10, the unmounting processing module 20, the mounting processing module 30, and other modules or submodules as described below, include computerized instructions in the form of one or more computer-readable programs that can be stored in the storage device of the terminal, and can be implemented by the at least one processor.

When an external storage device is mounted on the second operating system, the mounting requesting module 10 transmits a mounting request to the second operating system through the first operating system. Specifically, the user sends the mounting request by clicking a predetermined icon, an item or inputting a predetermined gesture.

When the second operating system receives the mounting request, the unmounting processing module 20 automatically unmounts the external storage device that is mounted on the second operating system.

When the second operating system successfully unmounts the external storage device, the mounting processing module 30 automatically mounts the external storage device on the first operating system.

Preferably, the mounting requesting module 10 includes:

An icon displaying submodule 11, which displays an one-click mounting icon in the first operating system.

A request generating submodule 12, which generates the mounting request and transmits the mounting request to the second operating system when the one-click mounting icon receives a predetermined touch instruction.

For example, the one-click mounting icon is separately added on a desktop of the ordinary system and a desktop of the security system, the desktop ordinary system uses a square icon, the security system uses a shield icon. The user can do mounting operation with clicking one button by the one-click mounting icon. For example, when the user clicks the one-click mounting icon of the security system, the external storage device mounted on the ordinary system is automatically unmounted, and the external storage device is automatically mounted on the security system. Whereas, if the user is using the ordinary system, the external storage device is mounted on the security system, and the user thinks of using the external storage device in the ordinary system, the user clicks the one-click mounting icon of the ordinary system, a mounting processing procedure of the ordinary system is the same as a mounting processing procedure of the security system. Whereby, a mount by clicking one button of the external storage device can be realized in the security system or the ordinary system.

Preferably, the mounting requesting module 10 includes:

A request transmitting submodule 13, which transmits the mounting request to a communal unit through the first operating system. The first operating system and the second operating system are not completely isolated in the dual system of the communication terminal, the first operating system and the second operating system communicates with each other through the communal unit of the dual system. When the communication terminal starts, the external storage device is mounted on the ordinary system by default. Preferably, if the user is using the security system and the storage device is mounted on the ordinary system, and if the user wants to utilize the external storage device in the security system, the security system is controlled to generate the mounting request and the mounting request is broadcasted to the communal unit of the dual system. If the user is using the ordinary system, the storage device is mounted on the security system and the user wants to utilize the external storage device in the ordinary system, and if the security system is controlled to generate the mounting request and the mounting request is broadcasted to the communal unit of the dual system.

A request forwarding submodule 14, which forwards the mounting request to the second operating system through the communal unit of the dual system. Preferably, after the communal unit of the dual system receives a broadcast of the mounting request of the security system, the mounting request is broadcasted to the ordinary system. Or after the communal unit of the dual system receives a broadcast of the mounting request of the ordinary system, the mounting request is broadcasted to the security system.

The unmounting processing module 20 includes:

An unmounting processing submodule 21, which automatically unmounts the external storage device that is mounted on the second operating system and transmits a unmounting result to the communal unit of the dual system, when the second operating system receives the mounting request. For example, while the external storage device of the second operating system is being unmounted, and if a user of the second operating system is processing the external storage device, at this point, an unmounting failure occurs. Preferably, the external storage device mounted on the ordinary system is being unmounted when the ordinary system receives the broadcast of the mounting request. Then regardless of whether the unmounting result is successful or unsuccessful, the unmounting result is broadcasted to the communal unit of the dual system. Or the external storage device mounted on the security system is being unmounted when the security system receives the broadcast of the mounting request. Then regardless of whether the unmounting result is successful or unsuccessful, the unmounting result is broadcasted to the communal unit of the dual system.

A result forwarding submodule 22, which forwards the unmounting result to the first operating system through the communal unit of the dual system. Preferably, the communal unit of the dual system broadcasts the unmounting result to the security system after receiving the unmounting result. Or the communal unit of the dual system broadcasts the unmounting result to the ordinary system after receiving the unmounting result.

The mounting processing module 30 includes:

A mounting processing submodule 31, which automatically mounts the external storage device on the first operating system, when the first operating system receives the unmounting result that the external storage device is unmounted successfully. Preferably, the external storage device is automatically mounted on the security system when the security system receives the unmounting result, the ordinary system unmounts the external storage device successfully. Or the external storage device is automatically mounted on the ordinary system when the ordinary system receives the unmounting result, the security system unmounts the external storage device successfully. Better still, the user is prompted that the mount is finished when the first operating system finishes the mount.

A failure prompt submodule 32, which outputs an unmounting failure prompt, when the first operating system has received the unmounting result representing that the external storage device is unmounted unsuccessfully. Preferably, the unmounting failure prompt can prompts the user that the ordinary system has unmounted the external storage device unsuccessfully, and the user is prompted to manually unmount the external storage device by switching to the ordinary system. Preferably, the unmounting result is outputted when the security system has received the unmounting result representing that the external storage device is unmounted unsuccessfully. Or the unmounting failure prompt is outputted when the ordinary system has received the unmounting result representing that the external storage device is unmounted unsuccessfully.

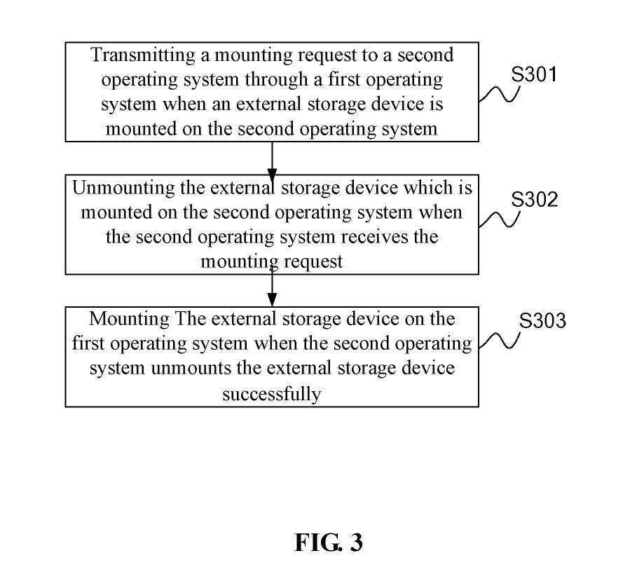

FIG. 3 shows a schematic flowchart of a mounting method of the external storage based on the dual system of the present disclosure. The dual system includes a first operating system and a second operating system, the first operating system is a security system or an ordinary system, the second operating system is a ordinary system or a security system. The mounting method can be executed through the mounting system 100 shown in FIG. 1 or FIG. 2. The mounting method includes:

Step S301, when the external storage device is mounted on the second operating system, a mounting request is transmitted to the second operating system through the first operating system.

The external storage device is SD (Secure Digital Memory Card), etc. Preferably, when a user is operating the security system and the external storage device is mounted on the ordinary system, if the user wants to mount the external storage device on the security system, the mounting request is transmitted to the ordinary system through the security system. Or when a user is operating the ordinary system, and the external storage device is mounted on the security system, if the user wants to mount the external storage device on the ordinary system, the mounting request is transmitted to the security system through the ordinary system. Specifically, the user sends the mounting request by clicking a predetermined icon, a menu item or inputting a predetermined gesture in the first operating system.

Step S302, when the second operating system receives the mounting request, the external storage device that is mounted on the second operating system is automatically unmounted.

Preferably, when the ordinary system receives the mounting request from the security system, the external storage device that is mounted on the ordinary system is unmonted. Or when the security system receives the mounting request from the ordinary system, the external storage device mounted on the security system is unmonted.

Step S303, when the second operating system successfully unmounts the external storage device, the external storage device is automatically mounted on the first operating system.

Preferably, when the ordinary system successfully unmounts the external storage device, the security system mounts the external storage device on the security system. Or when the security system successfully unmounts the external storage device, the ordinary system mounts the external storage device on the ordinary system.

It can be seen that the present disclosure can realize to a quick mounting of the external storage device in the security system, and a quick mounting of the external storage device in the ordinary system. The security system is utilized to process voice services, data of the voice services is security data and private data, such as, contacts, call logs, messages, and so on. The ordinary system is utilized to process data services, data of the data services is not security data, such as, browsing pages, watching online videos, and so on.

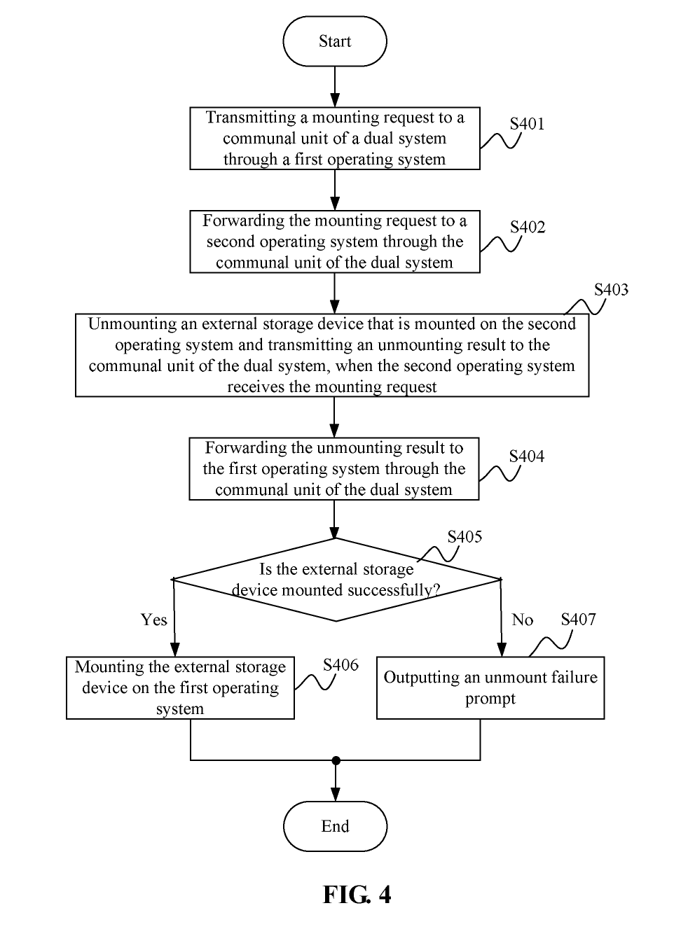

FIG. 4 shows a preferable schematic flowchart of the mounting method of the external storage based on the dual system of the present disclosure. The dual system includes a first operating system and a second operating system, the first operating system is a security system or a ordinary system, and the second operating system is an ordinary system or a security system. The mounting method can be executed through the mounting system 100 shown in FIG. 2. The mounting method includes:

Step S401, a mounting request is transmitted to a communal unit of the dual system through the first operating system.

The step preferably includes: displaying an one-click mounting icon in the first operating system; generating the mounting request and transmitting the mounting request to the second operating system when the one-click mounting icon receives a predetermined touch instruction.

For example, the one-click mounting icon is separately added on a desktop of the ordinary system and a desktop of the security system, the desktop ordinary system uses a square icon, the security system uses a shield icon. The user can do mounting operation with clicking one button by the one-click mounting icon. For example, when the user clicks the one-click mounting icon of the security system, the external storage device mounted on the ordinary system is automatically unmounted, and the external storage device is automatically mounted on the security system. Whereas, if the user is using the ordinary system, the external storage device is mounted on the security system, and the user thinks of using the external storage device in the ordinary system, the user clicks the one-click mounting icon of the ordinary system, a mounting processing procedure of the ordinary system is the same as a mounting processing procedure of the security system.

The first operating system and the second operating system are not completely isolated in the dual system of the communication terminal, the first operating system and the second operating system communicates with each other through the communal unit of the dual system. When the communication terminal starts, the external storage device is mounted on the ordinary system by default. Preferably, if the user is using the security system and the storage device is mounted on the ordinary system, and if the user thinks of utilizing the external storage device in the security system, the security system is controlled to generate the mounting request and the mounting request is broadcasted to the communal unit of the dual system. If the user is using the ordinary system, the storage device is mounted on the security system and the user thinks of utilizing the external storage device in the ordinary system, and if the security system is controlled to generate the mounting request and the mounting request is broadcasted to the communal unit of the dual system.

Step S402, the mounting request is forwarded to the second operating system through the communal unit of the dual system.

Preferably, after the communal unit of the dual system receives a broadcast of the mounting request of the security system, the mounting request is broadcasted to the ordinary system. Or after the communal unit of the dual system receives a broadcast of the mounting request of the ordinary system, the mounting request is broadcasted to the security system.

Step S403, when the second operating system receives the mounting request, the external storage device that is mounted on the second operating system is automatically unmounted and an unmounting result is transmitted to the communal unit of the dual system.

Preferably, the external storage device mounted on the ordinary system is being unmounted when the ordinary system receives the broadcast of the mounting request. Then regardless of whether the unmounting result is successful or unsuccessful, the unmounting result is broadcasted to the communal unit of the dual system. Peradventure, the external storage device mounted on the security system is being unmounted when the security system receives the broadcast of the mounting request. Then regardless of whether the unmounting result is successful or unsuccessful, the unmounting result is broadcasted to the communal unit of the dual system.

Step S404, the unmounting result is forwarded to the first operating system through the communal unit of the dual system.

Preferably, the communal unit of the dual system broadcasts the unmounting result to the security system after receiving the unmounting result. Or the communal unit of the dual system broadcasts the unmounting result to the ordinary system after receiving the unmounting result.

Step S405, it is determined that whether the unmounting result is that the external storage device is unmounted successfully, if yes, a step S406 is executed; if no, a step S407 is executed.

For example, while the external storage device of the second operating system is being unmounted, and if a user of the second operating system is processing the external storage device, at this point, an unmounting failure occurs.

Step S406, when the first operating system receives the unmounting result that the external storage device is unmounted successfully, the external storage device is automatically mounted on the first operating system.

Preferably, the external storage device is automatically mounted on the security system when the security system receives the unmounting result, the ordinary system unmounts the external storage device successfully. Or the external storage device is automatically mounted on the ordinary system when the ordinary system receives the unmounting result, the security system unmounts the external storage device successfully. Better still, the user is prompted that the mount is finished when the first operating system finishes the mount.

Step S407, when the first operating system has received the unmounting result that the external storage device is unmounted unsuccessfully, an unmounting failure prompt is outputted.

Preferably, the unmounting failure prompt can prompts the user that the ordinary system has unmounted the external storage device unsuccessfully, and the user is prompted to manually unmount the external storage device by switching to the ordinary system. Preferably, the unmounting result is outputted when the security system has received the unmounting result representing that the external storage device is unmounted unsuccessfully. Or the unmounting failure prompt is outputted when the ordinary system has received the unmounting result representing that the external storage device is unmounted unsuccessfully.

In conclusion, the present disclosures provides a new way of mounting the external storage device of the dual system. When the user is using the first operating system and the external storage device is mounted on the second operating system, and if the user wants mounting the external storage device on the first operating system, the mounting request is directly transmitted to the second operating system through the first operating system. The external storage device that is mounted on the second operating system is unmounted, and after unmounting the external storage device successfully, the external storage device is mounted on the first operating system. Operation steps of mounting the external storage device in the dual system are greatly simplified, so that it is convenient for users to utilize, and user experience is improved.

As shown in FIG. 5, according to one embodiment of the present disclosure, a communication terminal 600 includes the mounting system 100 as shown in FIG. 5. The communication terminal 600 may be a mobile phone, a tablet computer, a personal digital assistant, a notebook computer, or other computing device. The communication terminal 600 further includes at least one processor and a storage device, which are not shown in FIG. 5. FIG. 5 illustrates only one example of the communication terminal 600 that may include more or fewer components than illustrated, or have a different configuration of the various components.

The at least one processor is used to execute a plurality of modules or submodules in the mounting system 100 and other applications, such as an operating system, installed in the communication terminal 600. The storage devices store the computerized instructions of a plurality of units or subunits in the mounting system 100, and one or more programs, such as the operating system and applications of the communication terminal 600. The storage device can be any type of non-transitory computer-readable storage medium or other computer storage device, such as a hard disk drive, a compact disc, a digital video disc, a tape drive, a storage card (e.g., a memory stick, a smart media card, a compact flash card), or other suitable storage medium, for example.

The present disclosure certainly has multiply of other embodiments. Without departing from the substance and spirit of the present disclosure, one skilled in the art can do changes or modifications according to the present disclosure, but various changes or modifications may be made to the present disclosure.

What is claimed is:

1. A computer-implemented mounting method of an external storage device based on a dual system to a communication terminal, the dual system comprising a first operating system and a second operating system, the mounting method comprising:
transmitting a mounting request to the second operating system through the first operating system when the external storage device is mounted on the second operating system;
unmounting the external storage device that is mounted on the second operating system when the second operating system receives the mounting request;
mounting the external storage device on the first operating system when the second operating system unmounts the external storage device successfully.

2. The mounting method of claim 1, wherein the step of transmitting the mounting request to the second operating system through the first operating system by:
displaying an one-click mounting icon in the first operating system;
generating the mounting request and transmitting the mounting request to the second operating system when the one-click mounting icon receives a predetermined touch instruction.

3. The mounting method of claim 1, wherein the first operating system is a security system or an ordinary system, and the second operating system is an ordinary system or a security system.

4. The mounting method of claim 1, wherein the step of transmitting a mounting request to the second operating system through the first operating system comprises:
transmitting the mounting request to a communal unit of the dual system through the first operating system;
forwarding the mounting request to the second operating system through the communal unit of the dual system;
wherein when the second operating system receives the mounting request, the step of unmounting the external storage device that is mounted on the second operating system comprises:
unmounting the external storage device that is mounted on the second operating system and transmitting an unmounting result to the communal unit of the dual system, when the second operating system receives the mounting request;
forwarding the unmounting result to the first operating system through the communal unit of the dual system;
wherein when the second operating system successfully unmounts the external storage device, the step mounting of the external storage device on the first operating system comprises:
mounting the external storage device on the first operating system, when the first operating system receives the unmounting result representing that the external storage device is unmounted successfully.

5. The mounting method of claim 4, after the step of forwarding the unmounting resulting to the first operating system through the communal unit of the dual system, further comprising:
outputting an unmounting failure prompt, when the first operating system receives the unmounting result representing that the external storage device is unmounted unsuccessfully.

6. A communication terminal, comprising:
at least one processor; and
a storage device storing a plurality of instructions, which when executed by the processor, causes the at least one processor to:
transmit a mounting request to the second operating system through the first operating system when the external storage device is mounted on the second operating system;
unmount the external storage device that is mounted on the second operating system when the second operating system receives the mounting request;
mount the external storage device on the first operating system when the second operating system unmounts the external storage device successfully.

7. The communication terminal of claim 6, wherein the mounting request is transmitted to the second operating system through the first operating system by:
displaying an one-click mounting icon in the first operating system;
generating the mounting request and transmit the mounting request to the second operating system when the one-click mounting icon receives a predetermined touch instruction.

8. The communication terminal of claim 6 wherein the first operating system is a security system or an ordinary system, and the second operating system is an ordinary system or a security system.

9. The communication terminal of claim 6, wherein the mounting request is transmitted to the second operating system through the first operating system by:
transmitting the mounting request to a communal unit of the dual system through the first operating system;
forwarding the mounting request to the second operating system through the communal unit of the dual system;
wherein when the second operating system receives the mounting request, the external storage device that is mounted on the second operating system is unmounted by:
unmounting the external storage device that is mounted on the second operating system and transmiting a unmounting result to the communal unit of the dual system, when the second operating system receives the mounting request;
forwarding the unmounting result to the first operating system through the communal unit of the dual system;
wherein when the second operating system successfully unmounts the external storage device, the external storage device is mounted on the first operating system by:
mounting the external storage device on the first operating system, when the first operating system receives the unmounting result representing that the external storage device is unmounted successfully.

10. The communication terminal of claim 9, wherein after forwarding the unmounting resulting to the first operating system through the communal unit of the dual system, the at least one processor further:
outputs an unmounting failure prompt, when the first operating system has received the unmounting result representing that the external storage device is unmounted unsuccessfully.

11. A non-transitory storage medium having stored thereon instructions that, when executed by a processor of a communication terminal, causes the communication terminal to perform mounting method of an external storage device based on a dual system to the communication terminal, the method comprising:
transmitting a mounting request to the second operating system through the first operating system when the external storage device is mounted on the second operating system;
unmounting the external storage device that is mounted on the second operating system when the second operating system receives the mounting request;
mounting the external storage device on the first operating system when the second operating system unmounts the external storage device successfully.

12. The non-transitory storage medium according to claim 11, wherein the mounting request is transmitted to the second operating system through the first operating system by:
displaying an one-click mounting icon in the first operating system;
generating the mounting request and transmit the mounting request to the second operating system when the one-click mounting icon receives a predetermined touch instruction.

13. The non-transitory storage medium according to claim 11, wherein the first operating system is a security system or an ordinary system, and the second operating system is an ordinary system or a security system.

14. The non-transitory storage medium according to claim 1, wherein the mounting request is transmitted to the second operating system through the first operating system by:
transmitting the mounting request to a communal unit of the dual system through the first operating system;
forwarding the mounting request to the second operating system through the communal unit of the dual system;
wherein when the second operating system receives the mounting request, the external storage device that is mounted on the second operating system is unmounted by:
unmounting the external storage device that is mounted on the second operating system and transmiting a unmounting result to the communal unit of the dual system, when the second operating system receives the mounting request;
forwarding the unmounting result to the first operating system through the communal unit of the dual system;
wherein when the second operating system successfully unmounts the external storage device, the external storage device is mounted on the first operating system by: mounting the external storage device on the first operating system, when the first operating system receives the unmounting result representing that the external storage device is unmounted successfully.

15. The non-transitory storage medium according to claim 11, after the step of forwarding the unmounting resulting to the first operating system through the communal unit of the dual system, the method further comprising:
outputting an unmounting failure prompt, when the first operating system receives the unmounting result representing that the external storage device is unmounted unsuccessfully.
